(19) United States
(12) Patent Application Publication
(10) Pub. No.: US 2005/0187914 A1
(43) Pub. Date: Aug. 25, 2005

(54) Method and system for managing objects

(76) Inventors: Takeshi Fujita, Chiba-ken (JP); Tsutomu Kawachi, Tokyo (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/897,756

(22) Filed: Jul. 23, 2004

(30) Foreign Application Priority Data
Jul. 23, 2003 (JP) 2003-277999

(51) Int. Cl. G06F 7/00

(52) U.S. Cl. 707/3

(57) ABSTRACT

A processing means of an information providing system refers to a command information database and acquires object identifiers correlated to command identifiers. In the event that object path information correlated to an object identifier cannot be acquired from the command information database, the processing means refers to a public object database, and acquires object path information correlated to an object identifier corresponding to an object of another person. The processing means then executes objects correlated to command identifiers based on the acquired object identifier and object path information. As a result, the present invention is capable of providing an object management program capable of executing objects stored on another persons homepage region without the user knowing the storage location of the object in advance and without dependency on the type of terminal device.

### FIELD OF THE INVENTION

The present invention relates to a system for managing objects such as content etc. stored in a homepage region of an information providing system, and particularly to a distributed object utilization system for utilizing objects stored in homepage regions of other people.

### BACKGROUND OF THE INVENTION

Conventionally, it has been necessary to prepare Web pages having hyperlinks (Hyper link) such as prescribed link characters or icons etc. in advance in order to utilize objects such as content stored in a homepage region of another person or applications from a user's own homepage. The Web page hyperlink is correlated to the object of another person in advance. As a result, the object correlated to the hyperlink is executed upon the pressing of a prescribed hyperlink with a mouse etc.

However, in this example of the related art, it is necessary to acquire the storage location of the object stored at the homepage region of another person in advance, and make a hyperlink based on the storage location of the object. Further, there are cases where, depending on the type of terminal device, pictorial symbols such as icons etc. cannot be displayed and where Web pages having the hyperlink cannot be viewed. For example, there may be cases where a Web page cannot be displayed due to displaying limitations of a mobile telephone having an Internet browsing function (limitations such as not being able to display pictorial symbols such as icons).

The current applicant is unaware of any precedent technological documentation disclosing such technology.

### SUMMARY OF THE INVENTION

In order to resolve the inconvenience of the example of the related art, it is advantageous for the present invention to provide an object management program capable of executing objects stored on another persons homepage region without the user knowing the storage location of the object in advance and without dependency on the type of terminal device.

In order to resolve the aforementioned problems, the present invention adopts the following configuration.

In an aspect of the present invention there is provided a method of providing information used in an information providing system or there is provided an information providing system,
(1) the information providing system having information storage means, communication means for communicating with the terminal devices, and processing means for controlling operations of each of said means, and comprising the steps of:
(2) the storage means storing in a command information database command identifiers for identifying commands, object identifiers for identifying objects, and object path information for identifying storage locations of objects in a correlated manner;
(3) the storage means or the storage means of an external device storing in a public object database object identifiers identifying published objects and object path information in a correlated manner;
and the processing means:
(4) receiving command identifiers sent from the terminal devices;
(5) referring to the command information database and acquiring object identifiers correlated to the received command identifiers;
(6) referring to the command information database and acquiring object path information correlated to the acquired object identifier;
(7) in the event that object path information correlated to an object identifier cannot be acquired from the command information database, referring to the public object database, and acquiring object path information correlated to an object identifier corresponding to an object of another person; and
(8) executing an object correlated to the command identifier based on the object identifier acquired in step (5) and object path information acquired in step (6) or step (7).

In a further aspect of the present invention, in the method for providing information or the information providing system, the processing means:
(1) acquires a public object database storing object identifiers for identifying published objects of other people and object path information for identifying storage locations of the objects in advance in a correlated manner; and
(2) stores the acquired public object database in the storage means.

As a result, the information providing system refers to the command information database and the public object database, and acquires and executes object information of other people correlated to the command identifiers sent from the terminal devices. It is therefore possible to provide a superior object management program that did not exist in the prior art that is capable of executing objects stored in a homepage region of another person even when the user does not know the storage location of the object in advance.

### BRIEF DESCRIPTION OF THE DRAWINGS

FIG. 1 is a block view showing an overall configuration for a system;

FIG. 2 is a block view showing a configuration for a terminal device;

FIG. 3 is a block view showing a configuration for a HTTP server;

FIG. 4 is a view showing a program etc. stored in a homepage region;

FIG. 5 is a view of a configuration for a user information database;

FIG. 6 is a view of a configuration for a command information database;

FIG. 7 is a view of a configuration for a public information database;

FIG. 8 is a view showing data flow for a terminal device and an HTTP server;

FIG. 9 is a view showing communication and processing for a terminal device 100a and an HTTP server 200a;

FIG. 10 is an example of a user interface screen;

FIG. 11 is a view showing a component of a first embodiment;

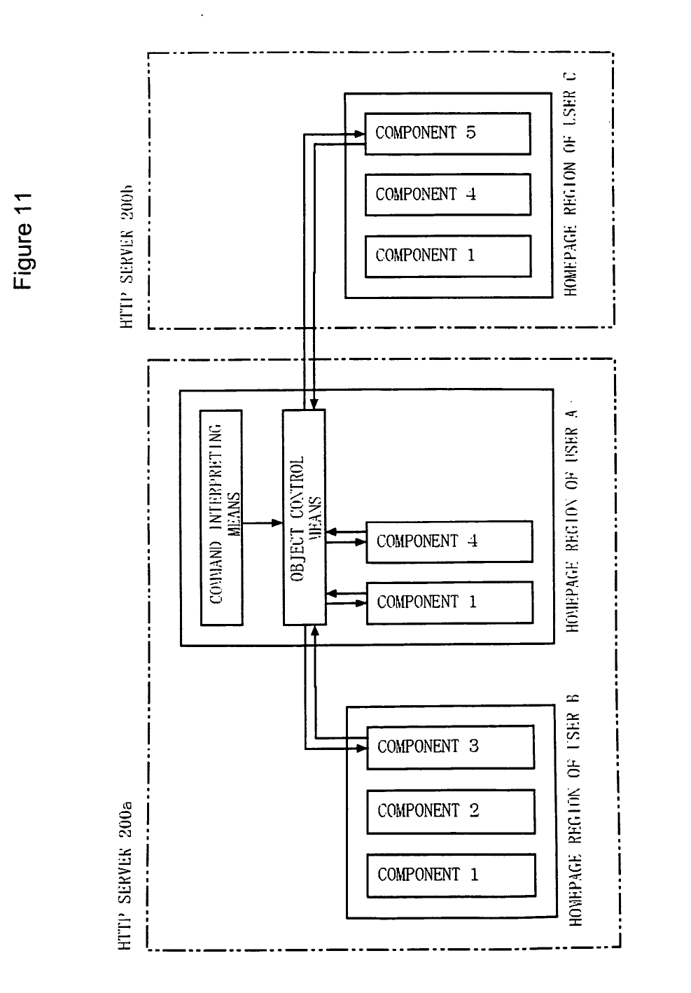

FIG. 12 is a view showing data stored in advance in a command information database in the first embodiment;

FIG. 13 is a view showing data stored in advance in a public object database in the first embodiment; and

FIG. 14 is a view showing a situation where an application corresponding to a specific command identifier is executed in the first embodiment.

### DETAILED DESCRIPTION OF ILLUSTRATIVE EMBODIMENTS

In the following, a detailed description of the present invention is given with reference to the drawings.

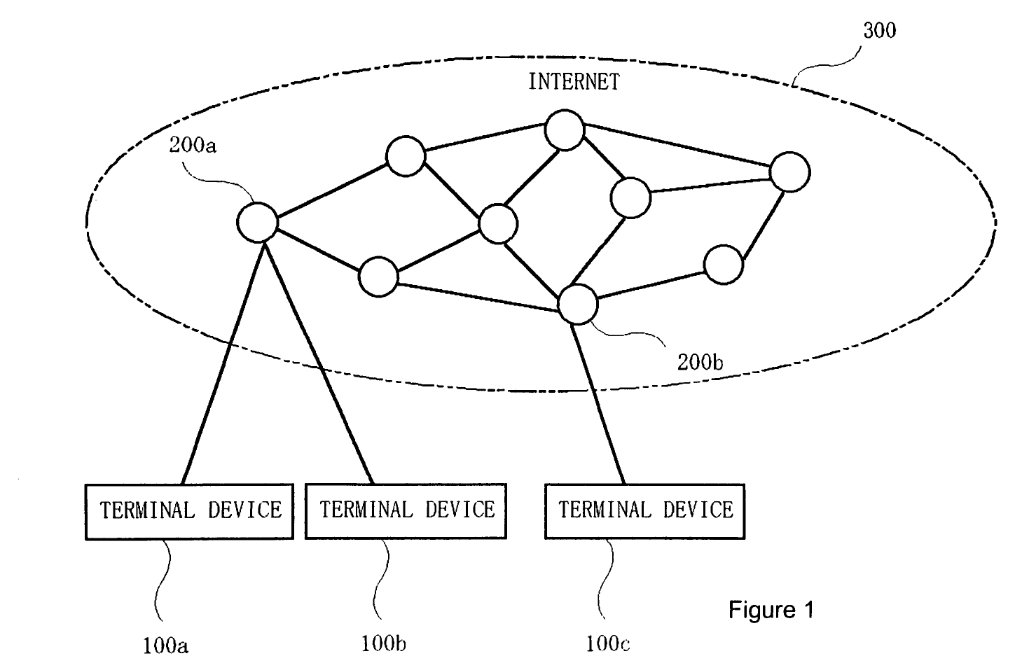

FIG. 1 is a block view showing an overall configuration for a system of an embodiment. A terminal device 100a, terminal device 100b and terminal device 100c are connected to the Internet 300 as a result of being connected to a HTTP server 200a and HTTP server 200b taken as an information providing system. The terminal device 100a is a terminal device utilized by a user A. A homepage region for user A is provided at the HTTP server 200a provided by the Internet provider (provider) utilized by user A. Further, the terminal device 100b is a terminal device utilized by a user B. A homepage region for user B is provided at the HTTP server 200a provided by the same Internet provider as for user A. Moreover, the terminal device 100c is a terminal device utilized by a user C. A homepage region for user C is provided at the HTTP server 200b provided by the Internet provider (provider) utilized by user C. The terminal device is then capable of browsing objects such as content stored in the homepage region of the HTTP servers and executing objects such as applications etc. via a WEB browser. On the other hand, the HTTP server interprets requests based on requests from the terminal device so as to execute the required applications, and sends the results of this processing to the terminal device.

In this case, “object” refers to resources stored in a storage region. An object may, for example, correspond to content such as files or folders etc. stored in a homepage region and applications etc. stored in a homepage region. Further, a terminal device is a device having an Internet connection function and may be connected to the Internet 300 using a wired connection or a wireless connection. The terminal device may be a PDA (Personal Digital Assistance) or mobile telephone having an Internet browsing function, etc.

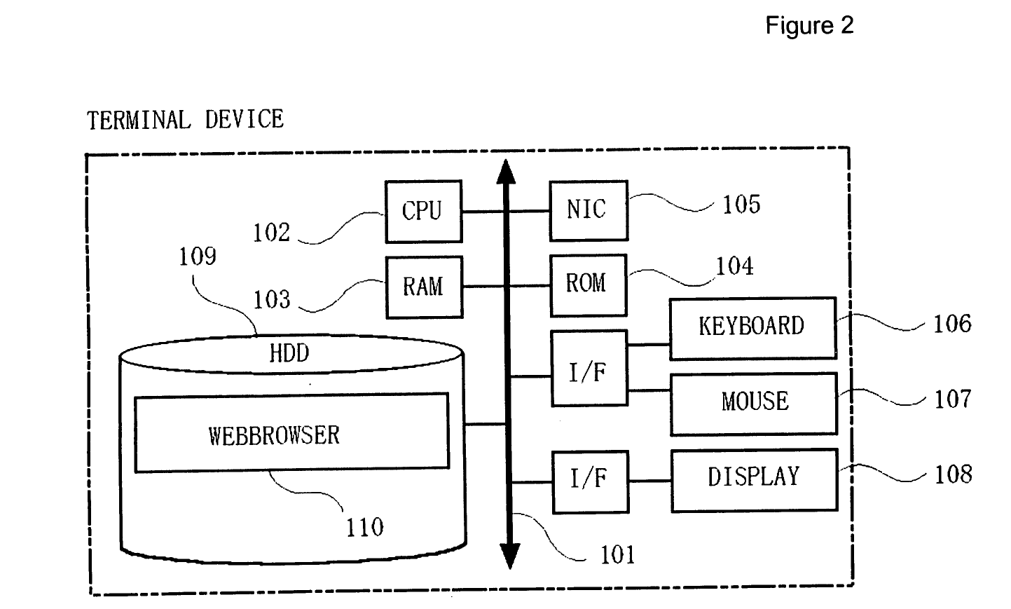

FIG. 2 shows a configuration for a typical PC (Personal Computer) taken as a terminal device. A keyboard 106 and mouse 107 taken as input means, a display 108 taken as display means, a CPU 102 taken as processing means, a RAM 103, ROM 104, and HDD 109 (Hard Disk Drive) taken as storage means, and an NIC 105 (Network Interface Card) taken as communication means are connected to a bus 101. I/F indicates an interface for between the bus and various devices. A WEB browser 110 etc. is stored in the HDD 109. The CPU 102 provides a function for sending requests to a HTTP server by reading a WEB browser 110 stored in the HDD 109 into RAM 103 and executing the WEB browser 110, and a function for receiving and displaying processing results from the HTTP server.

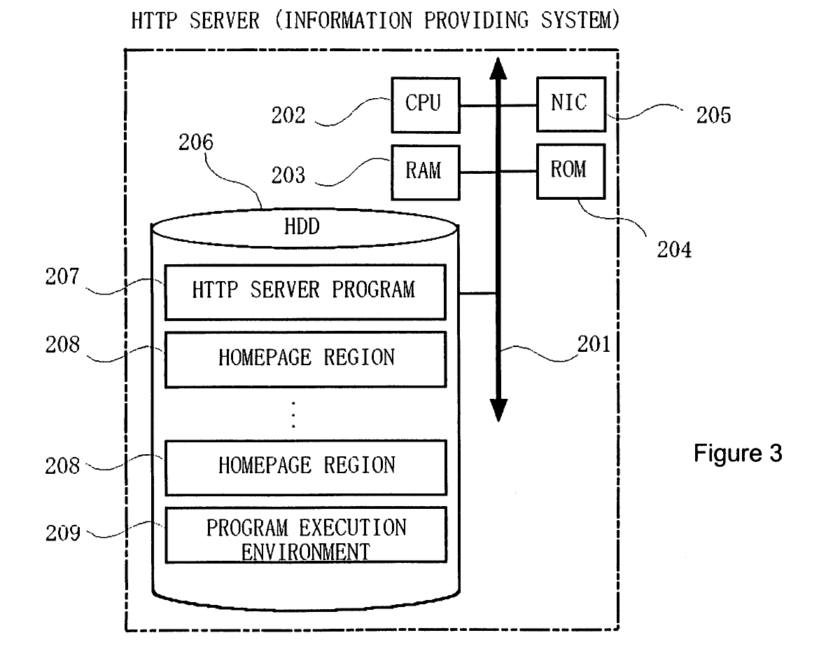

FIG. 3 shows a configuration for a HTTP server. The CPU 202 taken as the processing means, RAM 203, ROM 204 and HDD 206 (Hard Disk Drive) taken as the storage means and the NIC 205 (Network Interface Card) taken as the communication means are connected to the bus 201. I/F indicates an interface for between the bus and various devices. An HTTP server program 207, homepage region for each user, and program execution environment 209 for executing CGI (Common Gateway Interface) programs etc. are stored in the HDD 206. The CPU 202 provides a function for sending display control information for content etc. based on URLs (Uniform Resource Locators) transmitted via a WEB browser of a terminal device by reading the HTTP server program 207 stored in the HDD 206 and executing the HTTP server program 207.

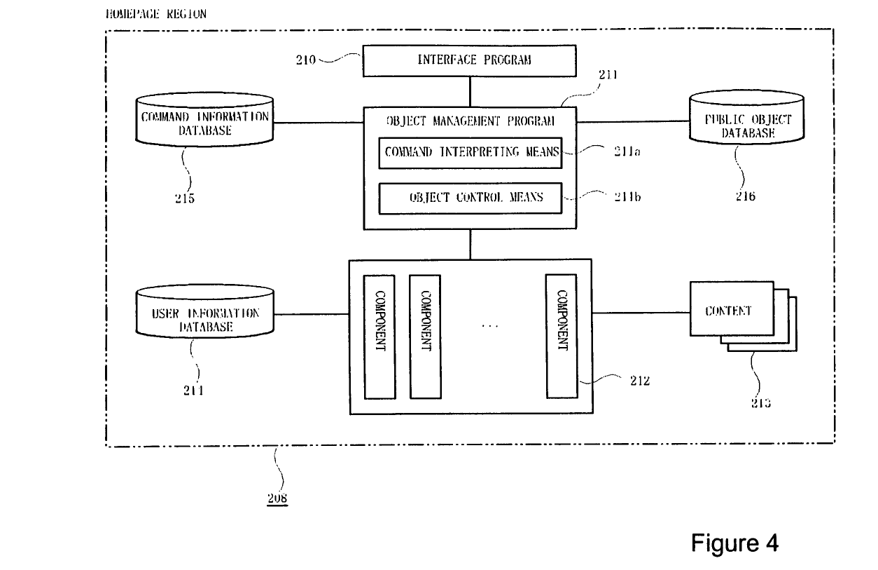

FIG. 4 shows programs etc. stored in a homepage region. Each user homepage region is equipped with an interface program 210 and object management program 211, a component 212, content 213, a user information database 214, a command information database 215, and a public object database 216.

By loading the interface program 210 into the RAM 203 and executing the interface program 210, the CPU 202 of the HTTP server provides a function for making display control information, and delivering the made display control information to the process of the HTTP server program 207. Further, by loading the object management program to RAM 203 and executing the object management program, the CPU 202 of the HTTP server is implemented by command interpreting means 211a for interpreting commands received from the process of the interface program 210, and object control means 211b for executing objects such as components 212 to be utilized based on the results of the interpreting. Further, the CPU 202 of the HTTP server is provided with prescribed functions as a result of loading a component 212 to the RAM 203 and executing the component 212.

Here, the component 212 is a program or program component for providing a specific function. Components 212 are preferably made so as to be classified into application components designed for providing a specified object, and system components designed to provide basic functions. By dividing components up into application components and system components, it is possible for the application components to utilize the system component functions, and effort involved in making duplicated functions is reduced. Application components may be, for example, an electronic mail component for transmitting and receiving electronic mail, or an editor component for providing a document editing function, etc. On the other hand, a system component may correspond to, for example, a component for providing an authentication function, a component for providing a shared desktop environment, or a component for providing a copy function for the content 213, etc.

The content 213 may be a file stored on a homepage region that is either made public or not made public on the Internet using a process of a HTTP server program 207. The content 213 may correspond to, for example, HTML (Hyper Text Markup Language) files, image files, audio files, moving image files, or folders etc.

The user information database 214 stores information for identifying users. The CPU 202 of the HTTP server refers to the user information database 214 and carries out authentication processing.

The command information database 215 stores information for identifying commands. The CPU 202 of the HTTP server refers to the command information database 215, interprets commands sent by the terminal device, and calls and executes prescribed objects.

The public object database 216 stores information for identifying objects published by each user. The CPU 202 of the HTTP server refers to the public object database 216 and is capable of utilizing objects stored and/or published in homepage regions of other people.

In this embodiment, the public object database 216 is prepared for respective homepage regions of each user. However, it is also possible to prepare just one public object database 216 at an external dedicated server, so that the published object is managed in a unified manner.

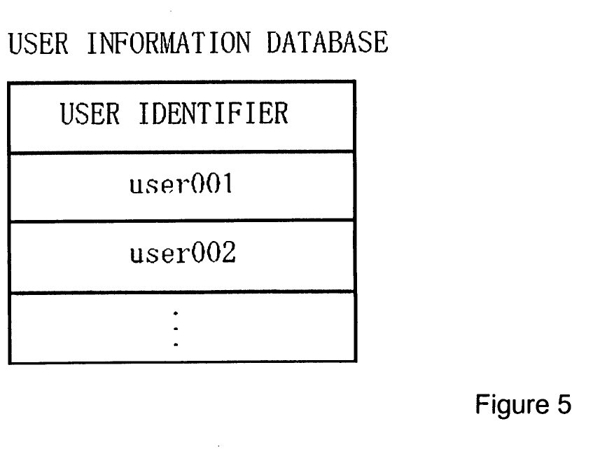

FIG. 5 shows a configuration for a user information database 214. The user information database 214 stores a user identifier for identifying users. Here, for example, a user ID identifying a user, password correlated to the user ID, and public key and secret key etc. correspond to the user identifier.

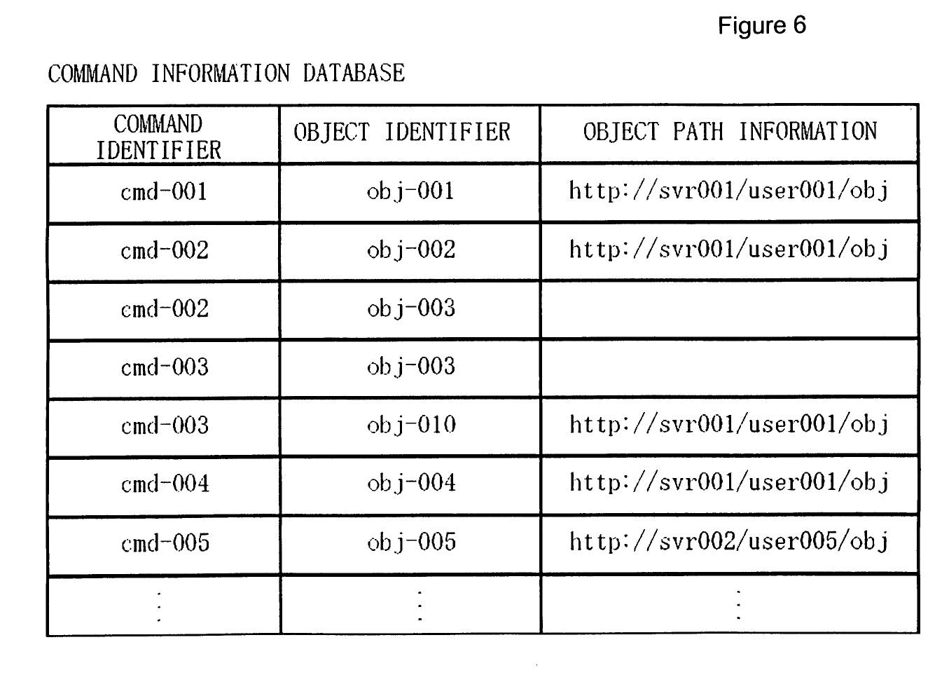

FIG. 6 shows a configuration for the command information database 215. The command information database 215 stores command identifiers for identifying commands, object identifiers for identifying objects, and object path information for identifying storage locations of objects in a correlated manner. Command identifiers correspond to, for example, a command “cp” for copying content 213 stored in the homepage region and a command “mail” for executing an electronic mail application, etc. Further, object identifiers correspond to, for example, an “ID number” for identifying an object, and a “name” of an object, etc. Further, object path information corresponds to, for example, URLs (Uniform Resource Locators) and relative paths or absolute paths identifying the HTTP servers.

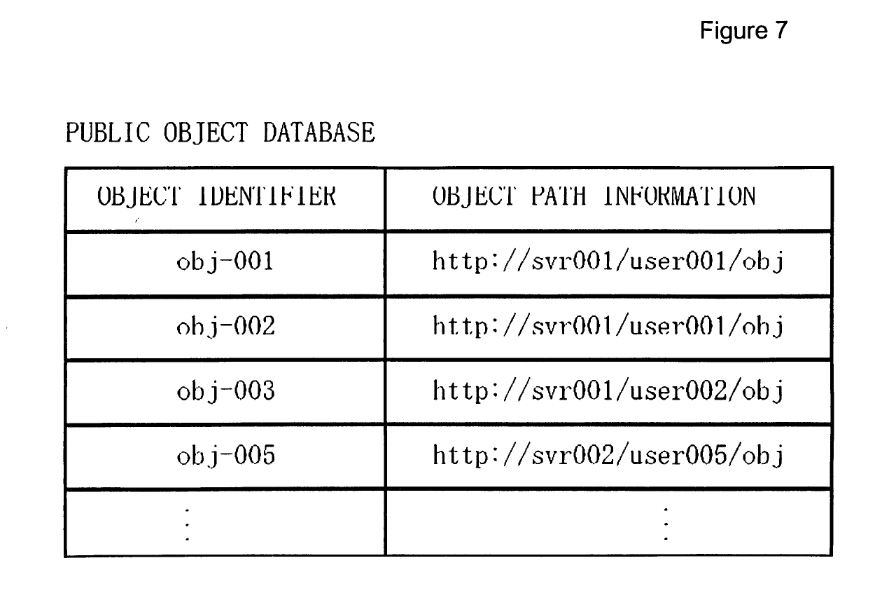

FIG. 7 shows a configuration for the public information database 216. The public object database 216 stores object identifiers for identifying published objects and object path information in a correlated manner. When a prescribed object identifier and object information are stored in a correlated manner at the public object database 216, this means that a prescribed object based on an object identifier exists at a storage location based on the object path information.

Here, “public objects” refers to objects that can be browsed or executed without inputting a password via a WEB browser of a terminal device in the event that object path information of the corresponding object is designated.

Next, a description is given of the operation of the system of this embodiment.

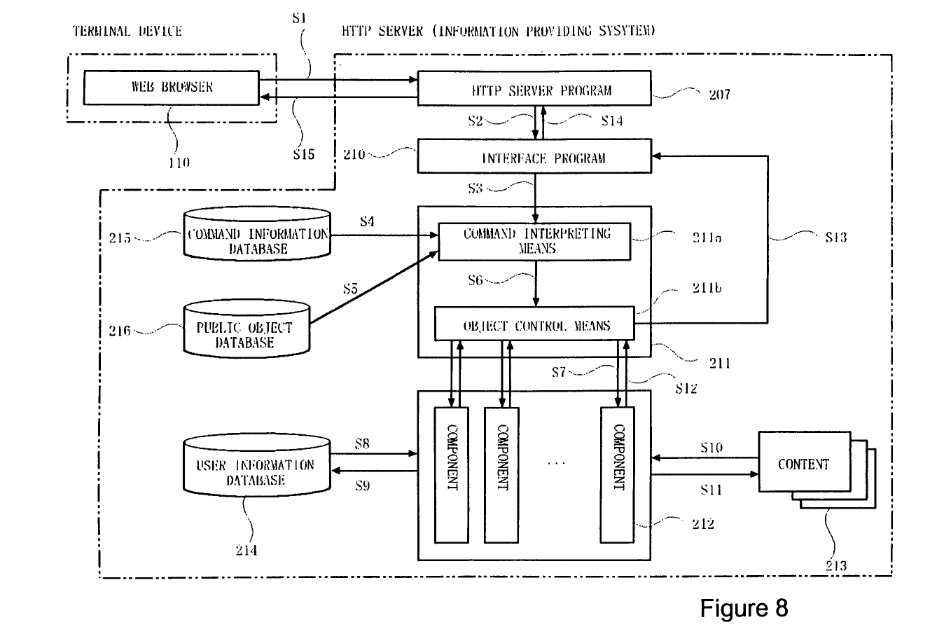

FIG. 8 is a view showing data flow for a terminal device and an HTTP server. The CPU 102 of the terminal device sends a command identifier inputted from a WEB browser to an HTTP server (S1). Here, communication between the terminal device and the HTTP server may utilize SOAP (Simple Object Access Protocol). Further, HTTP (HyperText Transfer Protocol), SMTP (Simple Mail Transfer Protocol), and FTP (File Transfer Protocol) etc. may be utilized as the lower order protocol used in transmitting and receiving data.

In this embodiment, a “command identifier” means a command identifier that is the same as or analogous to a command utilized in UNIX (R) but a command identifier employing a specific mother tongue is also possible. For example, “list” of the Japanese Language may also be allotted as a command identifier for displaying a list of files contained in a specific folder.

The CPU 202 of the HTTP server that has received the command identifier then passes the received command identifier over to the interface program 210 using a process of the HTTP server program 207 (S2). Next, the CPU 202 of the HTTP server delivers the passed over object to a process of the object management program using a process of the interface program 210 (S3). The CPU 202 of the HTTP server then carries out the following process using the command interpreting means 211a implemented using a process of the object management program 211. The CPU 202 of the HTTP server then refers to the command information database 215 and acquires an object identifier correlated to the command identifier passed over from the process of the interface program 210 (S4). Continuing on, the CPU 202 of the HTTP server refers to the command information database 215 and retrieves object path information correlated to the acquired object identifier.

The following is a description divided up into events where object path information can and cannot be acquired.

“The Event where Object Path Information can be Acquired from the Command Information Database”

The CPU 202 of the HTTP server then hands over the object identifier and object path information correlated to the object identifier to the object control means 211b implemented by a process of the object management program 211 (S6). The CPU 202 of the HTTP server then carries out the following process using the object control means 211b implemented by a process of the object management program 211. The CPU 202 of the HTTP server then executes a corresponding object based on the object identifier and the object path information passed over from the command interpreting means 211a (S7). The CPU 202 of the HTTP server refers to (S8) or edits (S9) the user information database 214 according to the executed object. Further, the CPU 202 of the HTTP server refers to (S10) or edits (S11) the content 213 according to the executed object.

The object identifier and correlated object path information stored at the command information database 215 are registered in advance in a manner relating to objects of a persons own homepage region. However, these values may be set in the event that the object identifier relating to an object of another person and correlated object path information can be acquired in advance. For example, this corresponds to the case where an object identifier of another person and object path information can be acquired in advance by an electronic mail program, etc.

As a result, in the event of utilizing an object that is not stored in a person's own homepage region, utilization of objects of other people published in such a manner that use is restricted to between friends etc. is possible.

“The Event where Object Path Information cannot be Acquired from the Command Information Database”

The CPU 202 of the HTTP server then carries out the following process using the command interpreting means 211a implemented using a process of the object management program 211. The CPU 202 of the HTTP server refers to the public object database 216 and retrieves object information correlated to the object identifier acquired in step S4 (S5). In the event that object path information can be acquired, the CPU 202 of the HTTP server passes the object identifier acquired in step S4 described above and object information correlated to the object identifier is passed over to the object control means 211b (S6). The CPU 202 of the HTTP server then carries out the following process using the object control means 211b implemented using a process of the object management program 211. The CPU 202 of the HTTP server then executes a corresponding object based on the object identifier and the object path information passed over from the command interpreting means 211a (S7). The CPU 202 of the HTTP server refers to (S8) or edits (S9) the user information database 214 according to the executed object. Further, the CPU 202 of the HTTP server refers to (S10) or edits (S11) the content 213 according to the executed object.

As a result, in the event of utilizing an object that is not stored in a person's own homepage region, utilization of objects published by other people is possible.

In the following, a continuation of the operation divided into the above cases is described.

After this, the CPU 202 of the HTTP server, the processing results obtained through execution of the object are passed over to the object control means 211b. The CPU 202 of the HTTP server then passes over the passed over processing results to a process of the interface program 210 (S13).

The CPU 202 of the HTTP server carries out the following processing using a process of the interface program 210. The CPU 202 of the HTTP server dynamically produces display control information described using display control information descriptor language such as HTML (Hyper Text Markup Language) or DHTML (Dynamic Hyper Text Markup Language) etc. based on the processing results passed over from the object processing means. Next, the CPU 202 of the HTTP server passes over the display control information produced in this manner to a process of the HTTP server program 207 (S14).

Next, the CPU 202 of the HTTP server carries out the following processing using a process of the HTTP server program 207. The CPU 202 of the HTTP server sends the display control information passed over from the process of the interface program 210 to the terminal device (S15).

On the other hand, the CPU 102 of the terminal device 100a displays processing results corresponding to the command identifier via the WEB browser based on the received display control information.

As in the above, the HTTP server refers to the command information database 215 and the public object database 216 and acquires object path information for other people correlated to command identifiers sent from the terminal device. The terminal device can therefore display processing results corresponding to the command identifier at the display means even when the object corresponding to the command identifier is not stored on their own homepage region.

In the following, a description is given of practical examples where a user A executes objects of another person (user B and user C).

The terminal devices utilized by user A, user B and user C and the configuration and operation of the HTTP server are the same as described in FIG. 1 to FIG. 8.

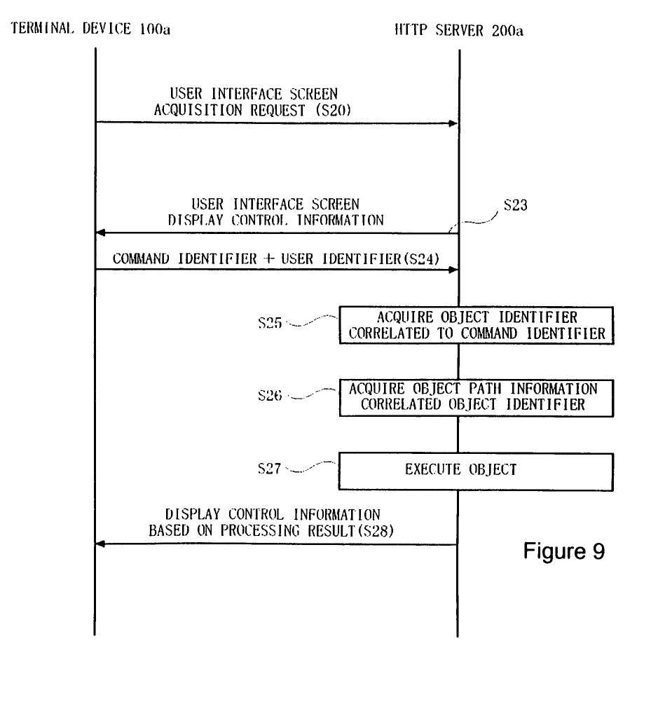

FIG. 9 shows processing for communication between the terminal device 100a and the HTTP server 200a.

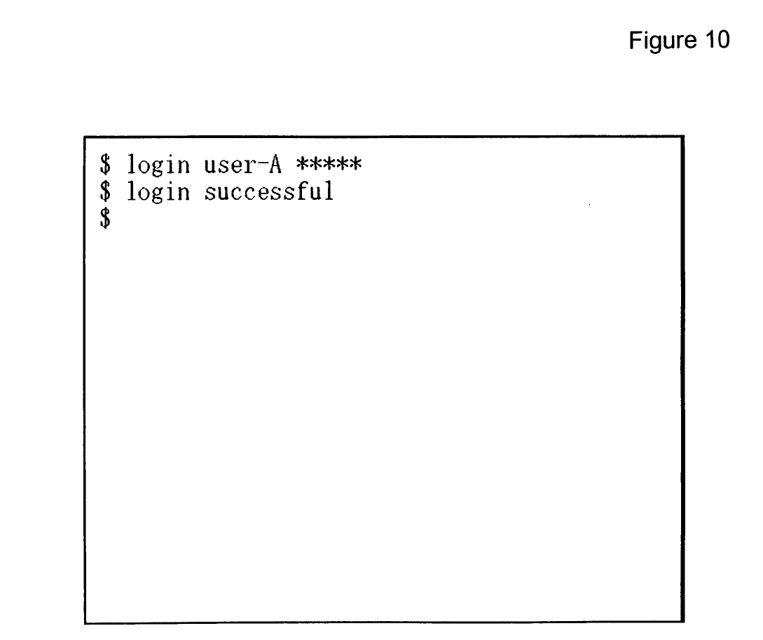

The CPU 102 of the terminal device 100a sends display requests of a user interface screen to the HTTP server 200a in accordance with a URL inputted from the WEB browser (S20). The CPU 202 of the HTTP server 200a receiving the display request sends display control information of the user interface screen to the terminal device (S23). The CPU 102 of the terminal device then displays the user interface screen at the WEB browser based on the received display control information. A typical CUI (Character User Interface) is adopted as the user interface screen. FIG. 10 is an example of a user interface screen. When a user wishes to execute a prescribed command, a prescribed command identifier is inputted from the keyboard 106 to the input line of the user interface screen.

The user A of the terminal device 100 inputs a command identifier “login” of an authentication command to the command input line of the user interface screen from the keyboard 106. Here, in this embodiment, the argument inputted after the “login” command is “user ID”, the argument inputted next is “password”. In the example of FIG. 10, “user-A” is inputted as the “user ID” of user A and “*****” is inputted as the password. In the event of executing a command, the execution keys “Enter” and “Return” etc. of the keyboard 106 are pressed down.

The CPU 102 of the terminal device 100a for which the execution key is pressed down then sends a command identifier and user identifier inputted from the keyboard 106 to the HTTP server 200a (S24). The CPU 202 of the HTTP server 200a receiving the command identifier and the user identifier then refers to the command information database 215 and acquires an object identifier correlated to the received command identifier (S25). Objects corresponding to the authentication commands “login” are prepared at homepage regions for every user as components of the system providing the basic functions and object identifiers correlated to the command identifiers can be acquired from the command information database 215. The CPU 202 of the HTTP server 200a acquires object path information correlated to the acquired object identifier from the command information database 215 (S26). The CPU 202 of the HTTP server 200a then executes an object corresponding to the authentication command based on the acquired object path information (S27). The CPU 202 of the HTTP server 200a then compares the received user identifier and the user identifier stored in the user information database 214 using a process for an object corresponding to the authentication command. In the event that a user identifier that is the same as the received user identifier is present in the user information database 214, the CPU 202 of the HTTP server 200a sends an authentication successful message to the terminal device (S28). On the other hand, in the event that a user identifier that is the same as the received user identifier is not present in the user information database 214, the CPU 202 of the HTTP server 200a sends an authentication failed message to the terminal device (S28). In FIG. 10, a message of “login successful” is sent by the CPU 202 of the HTTP server 200a to the terminal device as an example of where authentication is successful, and the CPU 102 of the terminal device displays the message at the user interface screen of the WEB browser. In this embodiment, the component corresponding to the command identifier “login” is stored at the persons own homepage region as a system component but this may also be stored in the homepage region of another person.

Next, a description is given of the case where user A inputs a command identifier “cmd-xxx” for executing a specific application from the user interface screen from the keyboard 106.

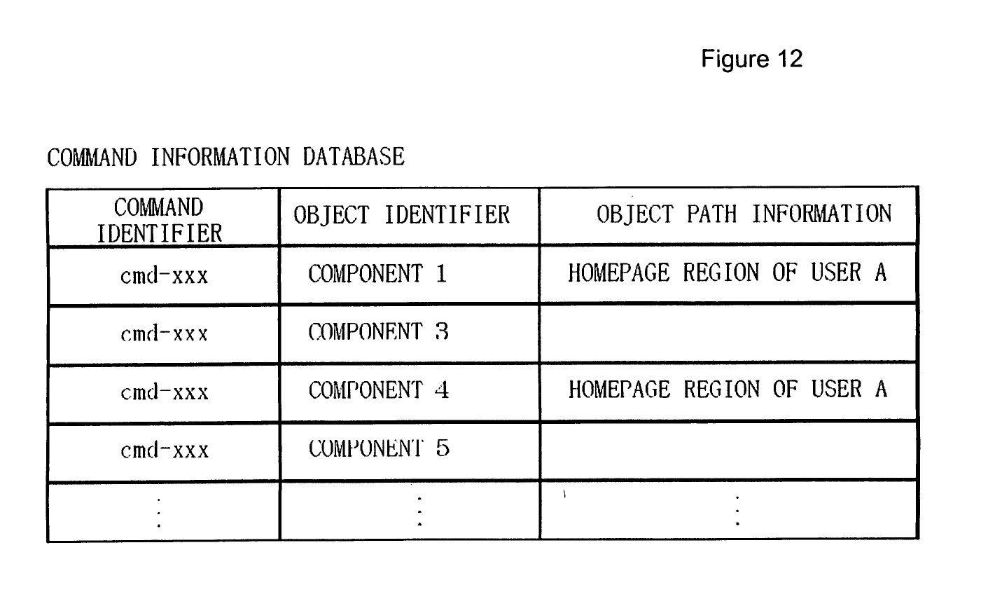

Here, the component 1 and component 4 are stored as objects in the homepage region of user A, and component 1, component 2 and component 3 are stored as objects in the homepage region of user B. Component 1, component 4 and component 5 are stored as objects in the homepage region of user C. FIG. 12 is a view showing the configuration of components stored in homepage regions of each of user A, user B and user C.

Further, the object identifiers correlated to the command identifiers “cmd-xxx” are taken to be component 1, component 3, component 4 and component 5. Moreover, the object identifiers “component 1” and “component 4” are taken to be respectively correlated to the object path information “homepage region of user A”. FIG. 12 shows a situation where the command identifier “cmd-xxx”, object identifier, and object path information are stored in a correlated manner in the command information database 215.

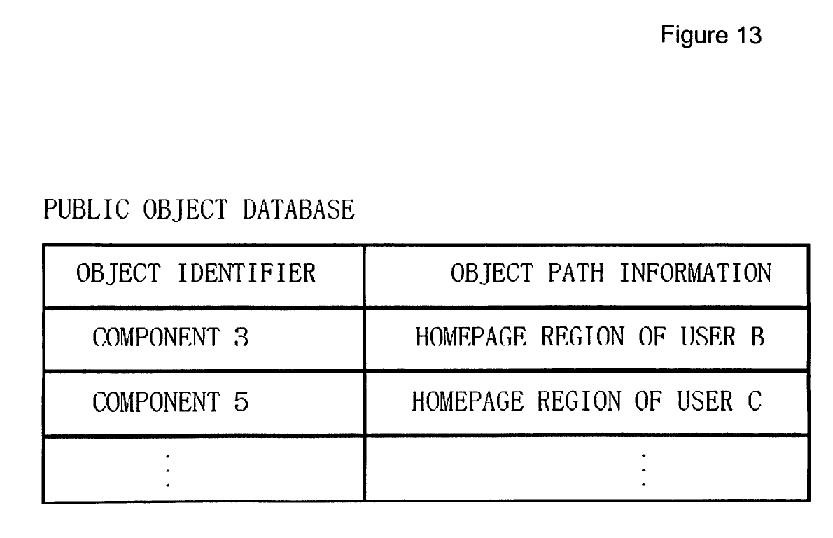

Further, component 3 is stored as a published object in the homepage region of user B existing on the same HTTP server 200a as utilized by user A, and component 5 is stored as a published object in the homepage region of user C existing on the HTTP server 200b that is separated from the HTTP server utilized by user A. FIG. 13 shows a state where published objects and object path information are stored in a correlated manner in the public object database 216.

Next, a description is given of the operation after user A inputs “cmd-xxx” constituting a command identifier for executing a specific application from the user interface screen.

The CPU 102 of the terminal device 100a sends a command identifier “cmd-xxx” inputted using the keyboard 106 from the user interface screen to the HTTP server 200a.

The CPU 202 of the HTTP server 200a receiving the command identifier “cmd-xxx” then refers to the command information database 215 and acquires “component 1”, “component 3”, “component 4” and “component 5” as object identifiers correlated to the command identifier. The CPU 202 of the HTTP server 200a acquires object path information correlated to the acquired object identifier. In this embodiment, the CPU 202 of the HTTP server 200a is capable of acquiring “homepage region of user A” constituted by object path information respectively correlated to the object identifiers “component 1” and “component 4”. Here, the CPU 202 of the HTTP server 200a cannot acquire object information from the command information database 215 because object path information is not correlated with respect to the object identifiers “component 3” and “component 5”. In this case, the CPU 202 of the HTTP server 200a refers to the public object database 216 and acquires object path information correlated to the object identifiers “component 3” and “component 5”. In this embodiment, the CPU 202 of the HTTP server 200a is capable of acquiring object path information “homepage region of user B” and “homepage region of user C” respectively correlated to the object identifiers “component 3” and “component 5”. In this way, the CPU 202 of the HTTP server 200a is capable of acquiring the object identifier correlated to command identifier “cmd-xxx” and object path information.

The CPU 202 of the HTTP server 200a then executes an object corresponding to command identifier “cmd-xxx” based on the acquired object identifier and object path information. Here, the CPU 202 of the HTTP server 200b executes “component 5” stored in the homepage region of user C but it is also possible for the CPU 202 of the HTTP server 200a to temporarily or permanently copy “component 5” stored in the homepage region of user C for execution. While executing objects of other people, it is also possible for the CPU 202 of the HTTP server 200a to send an execution request to a process of the object management program stored in a homepage region of another person, so that an object requested by a process of the object management program receiving the execution request is executed. It is also possible to utilize SOAP (Simple Object Access Protocol) for communication between processes. The CPU 202 of the HTTP server 200a makes display control information based on processing results acquired by the process of the executed object. The CPU 202 of the HTTP server 200a sends the made display control information to the terminal device.

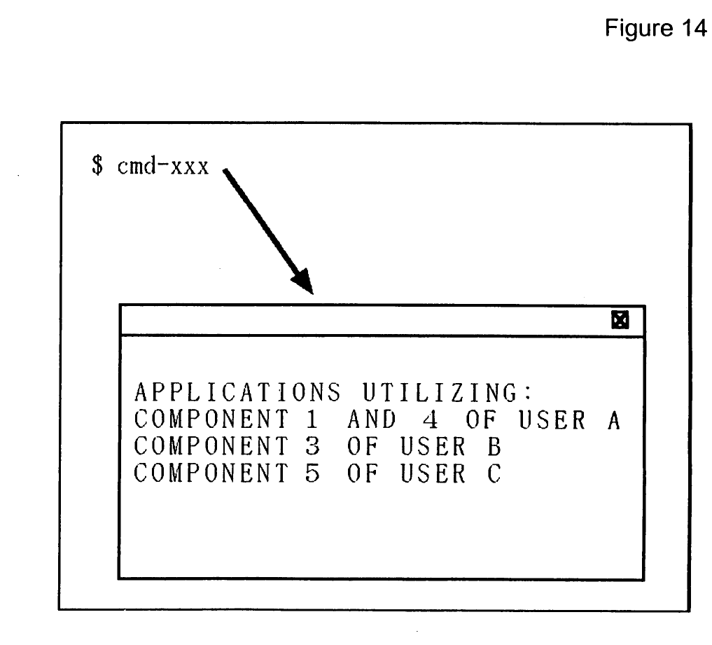

On the other hand, the CPU 102 of the terminal device 100a displays a screen of an application corresponding to the command identifier “cmd-xxx” via a browser based on the received display control information (FIG. 14).

As in the above, the HTTP server refers to the command information database 215 and the public object database 216 and acquires object path information for other people correlated to command identifiers sent from the terminal device. The terminal device can therefore execute an application corresponding to the command identifier even when the object corresponding to the command identifier is not stored on their own homepage region.

1. A method for providing information employed in an information providing system,
(1) the information providing system having information storage means, communication means for communicating with the terminal devices, and processing means for controlling operations of each of said means, comprising the steps of:
(2) the storage means storing in a command information database command identifiers for identifying commands, object identifiers for identifying objects, and object path information for identifying storage locations of objects in a correlated manner;
(3) the storage means or the storage means of an external device storing in a public object database object identifiers identifying published objects and object path information in a correlated manner;
and the processing means:
(4) receiving command identifiers sent from the terminal devices;
(5) referring to the command information database and acquiring object identifiers correlated to the received command identifiers;
(6) referring to the command information database and acquiring object path information correlated to the acquired object identifier;
(7) in the event that object path information correlated to an object identifier cannot be acquired from the command information database, referring to the public object database, and acquiring object path information correlated to an object identifier corresponding to an object of another person; and
(8) executing an object correlated to the command identifier based on the object identifier acquired in step (5) and object path information acquired in step (6) or step (7).

2. The method for providing information as disclosed in claim 1, wherein the processing means:
(1) acquires a public object database storing object identifiers for identifying published objects of other people and object path information for identifying storage locations of the objects in advance in a correlated manner; and
(2) stores the acquired published object database in the storage means.

3. An information providing system for providing information,
(1) the information providing system having information storage means, communication means for communicating with the terminal devices, and processing means for controlling operations of each of said means, comprising the steps of:
(2) the storage means storing in a command information database command identifiers for identifying commands, object identifiers for identifying objects, and object path information for identifying storage locations of objects in a correlated manner;
(3) the storage means or the storage means of an external device storing in a public object database object identifiers identifying published objects and object path information in a correlated manner;
and the processing means:
(4) receiving command identifiers sent from the terminal devices;
(5) referring to the command information database and acquiring object identifiers correlated to the received command identifiers;
(6) referring to the command information database and acquiring object path information correlated to the acquired object identifier;
(7) in the event that object path information correlated to an object identifier cannot be acquired from the command information database, referring to the public object database, and acquiring object path information correlated to an object identifier corresponding to an object of another person; and
(8) executing an object correlated to the command identifier based on the object identifier acquired in step (5) and object path information acquired in step (6) or step (7).

4. The information providing system as disclosed in claim 3, wherein the processing means:
(1) acquires a public object database storing object identifiers for identifying published objects of other people and object path information for identifying storage locations of the objects in advance in a correlated manner; and
(2) stores the acquired published object database in the storage means.
